(19) United States
(12) Patent Application Publication
(10) Pub. No.: US 2013/0111523 A1
(43) Pub. Date: May 2, 2013

(54) DEVICE AND METHOD FOR RECEIVING MULTI-CHANNEL BROADCASTING

(71) Applicant: SAMSUNG ELECTRONICS CO., LTD., Suwon-si (KR)

(72) Inventor: Dong-uk SEO, Cheonan-si (KR)

(73) Assignee: SAMSUNG ELECTRONICS CO., LTD., Suwon-si (KR)

(21) Appl. No.: 13/661,283

(22) Filed: Oct. 26, 2012

(30) Foreign Application Priority Data
Oct. 27, 2011 (KR) 10-2011-0110583

(51) Int. Cl. H04N 21/482

(52) U.S. Cl. 725/39; 725/38

(57) ABSTRACT

Provided is a device for receiving multi-channel broadcasting and a method thereof. The device for receiving multi-channel broadcasting includes a signal receiving unit which receives a broadcast signal, a control unit which controls the signal receiving unit to select a channel selected by a user and receive the broadcast signal and a signal processing unit which modulates a broadcast signal received from the signal receiving unit with a digital modulation method in accordance with a predetermined broadcasting standard.

### CROSS-REFERENCE TO RELATED APPLICATION

This application claims priority from Korean Patent Application No. 10-2011-0110583, filed on Oct. 27, 2011, in the Korean Intellectual Property Office, the entire disclosure of which is incorporated herein by reference.

### BACKGROUND

1. Field

Apparatuses and methods consistent with exemplary embodiments relate to receiving multi-channel broadcasting and, more particularly, to a device such as Set Top Box which uses a method of digital modulation to output a channel having a large data amount in High Definition (HD) without downgrading a display quality.

2. Description of the Prior Art

With the advent of a digital broadcast service, the number of channels transmitted from terrestrial, cable and satellite broadcasting companies has increased to more than 100. To receive such a number of channels, a digital Set Top Box is inevitably needed. A digital Set Top Box receives a digital broadcast signal from a digital broadcasting company and performs a data-processing to output the broadcast signal through a TV or a VTR (Video Tape Recorder). For example, a digital Set Top Box demodulates a digital broadcast signal received from a digital broadcasting company and outputs the same through an output terminal such as an Audio/Video (A/V) terminal, a component terminal, a Radio Frequency (RF) modulator and the like.

In the process, if NTSC is the broadcast standard, an RF module needs to be adapted for RF output of Channel 3 at 61.25 MHz and Channel 4 at 67.25 MHz. If Channel 3 is output, the frequency bandwidth is 6 MHz, ranging from 60 to 66 MHz, with a video carrier at 61.25 MHz, a color carrier at 64.83 MHz and an audio carrier at 65.75 MHz. In the case of Korea, a second audio carrier is transmitted as well, 0.22 MHz located after a first audio carrier.

However, if a digital Set Top Box receives data of high-definition image and audio using digital transmission and retransmits the same using an RF output, the Set Top Box modulates the data of high-definition image and audio into analog data, causing degradation in image and audio quality. In addition, if NTSC is a broadcast standard, transmitting a data to Channel 3 or Channel 4 uses a Channel bandwidth of 6 MHz as a total bandwidth, so only one channel can be transmitted. That is, it is impossible to load two or more programs on a video carrier at once.

Further, when an analog broadcast and a digital broadcast are being broadcast simultaneously, a bandwidth of a digital broadcast signal is always set to be lower than a bandwidth of an analog broadcast signal to avoid disrupting an analog channel. But, if a bandwidth of an analog signal closest to a digital signal is much higher than a bandwidth of the digital signal, a closest analog channel disrupts a digital channel, leading to reception issues. In particular, the second audio signal is merely dozens of KHz away from a digital channel, having a significant influence.

### SUMMARY

Accordingly, aspects of exemplary embodiments have been made to solve the above-mentioned disadvantages occurring in the prior art and other related disadvantages not described above. According to an aspect of an exemplary embodiment, there is provided a device for receiving multi-channel broadcasting which conducts digital modulation to choose a broadcast standard such as ATSC and a method thereof.

According to another aspect of an exemplary embodiment, there is provided a device for receiving multi-channel broadcasting including a signal receiving unit which receives a broadcast signal, a control unit which controls the signal receiving unit to select a channel selected by a user and receive the broadcast signal and a signal processing unit which modulates a broadcast signal received from the signal receiving unit with digital modulation in accordance with a predetermined broadcasting standard.

The signal processing unit may convert an analog signal into a digital signal or a received first digital signal into a second digital signal different from the first digital signal.

The signal processing unit may include a digital modulator which modulates a broadcast signal of the selected channel with at least one method of QAM (Quadrature Amplitude Modulation), OFDM (Orthogonal Frequency Division Multiplexing), VSB (Vestigial Side Band) and QPSK (Quadrature Phase Shift).

The signal processing unit may include a demux which divides a broadcast signal of the selected channel into video data and audio data and outputs the video and audio data, a video processor which performs a signal-processing of the video data and provides a result of the signal-processing to the digital modulator and an audio processor which performs a signal-processing of the audio data and provides a result of the signal processing to the digital modulator.

The digital modulator may comprise a plurality of digital modulators and the switching unit may include a switching unit which selects one of the plurality of digital modulators depending on a type of the broadcast signal.

A broadcast signal of the selected channel may include information about a plurality of programs.

A method for receiving multi-channel broadcasting includes selecting a channel selected by a user and receiving a broadcast signal, and modulating the received broadcast signal with a digital modulation method in accordance with a predetermined broadcasting standard and outputting the broadcast signal.

The modulating a broadcast signal with the digital modulation method and outputting the broadcast signal may include modulating the broadcast signal with at least one method of QAM, OFDM, VSB and QPSK.

The modulating a broadcast signal with the digital modulation method and outputting the broadcast signal may include converting a received first digital signal into a second digital signal in a different form from that of the first digital signal and outputting the second digital signal.

The modulating a broadcast signal with the digital modulation method and outputting the broadcast signal may include using at least one of broadcasting standards of ATSC (Advanced Television Systems Committee), COFDM (Coded Orthogonal Frequency Modulation), BST-OFDM (Bandwidth Segmented Transmission-OFDM), ISDB-T (Integrated Services Digital Broadcast-Terrestrial), DMB-T (Terrestrial Digital Multimedia Television Broadcasting), ADTB-T (Advanced Digital Television Broadcast-Terrestrial), BDB-T, CDTB-T and SMCC (Synchronized Multi-Carrier CDMA).

### BRIEF DESCRIPTION OF THE DRAWINGS

The above and/or other aspects will be more apparent from the following detailed description taken in conjunction with the accompanying drawings, in which:

FIG. 1 is a view illustrating an example of a device for receiving multi-channel broadcasting according to exemplary embodiments;

FIG. 2 is a block diagram illustrating a configuration of a device for receiving the multi-channel broadcasting according to FIG. 1;

FIG. 3 is a view illustrating an example of a configuration of a device for receiving the multi-channel broadcasting according to FIG. 2;

FIG. 4 is a view illustrating an example of a configuration of a device for receiving the multi-channel broadcasting according to FIG. 2; and

FIG. 5 is a diagram illustrating a method for receiving the multi-channel broadcasting according to exemplary embodiments.

### DETAILED DESCRIPTION

Hereinafter, exemplary embodiments will be described in greater detail with reference to the accompanying drawings, in which aspects of the exemplary embodiments are illustrated.

According to exemplary embodiments, a device for receiving multi-channel broadcasting may be an individual device such as a Set Top Box, a VTR, a VCR, a DVR (Digital Video Recorder), a DVD and the like, and, if the device is built inside of a digital TV, an A/V displaying apparatus and other receivers, it may be a device inside of those, or the digital TV, the A/V displaying apparatus and other receivers themselves. Herein, exemplary embodiments are provided regarding an individual device for convenience sake.

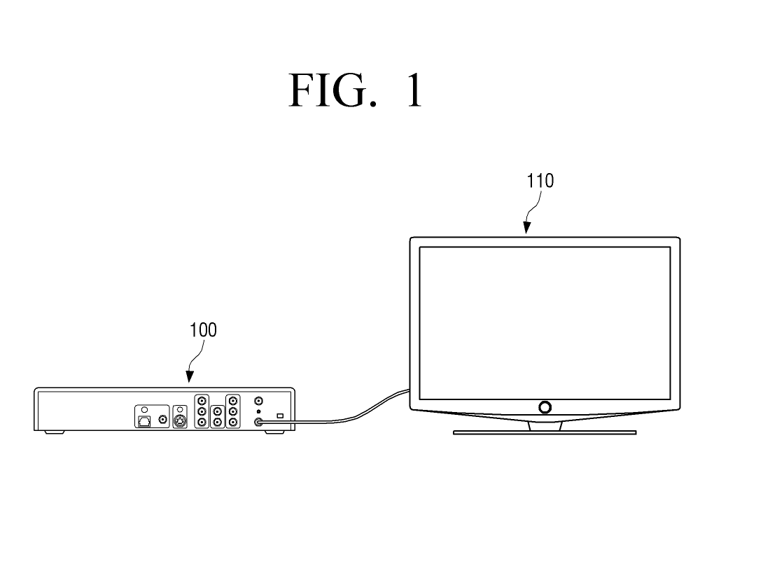

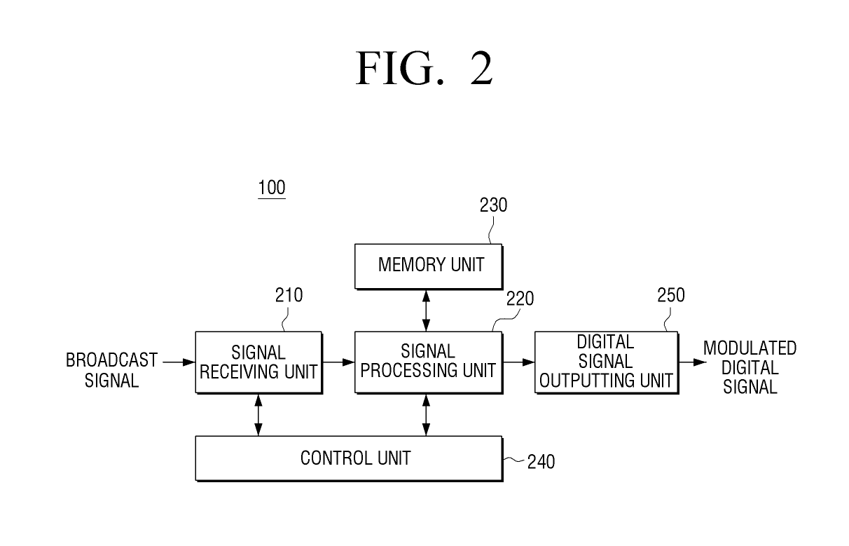

FIG. 1 is a view illustrating an example of a device for receiving multi-channel broadcasting according to exemplary embodiments and FIG. 2 is a block diagram illustrating a configuration of the device for receiving the multi-channel broadcasting according to FIG. 1.

As illustrated in FIGS. 1 and 2, according to exemplary embodiments, a system for receiving multi-channel broadcasting includes a device for receiving multi-channel broadcasting 100 and a receiver 110. Herein, the device for receiving multi-channel broadcasting 100 includes some or all of a signal receiving unit 210, a signal processing unit 220, a memory unit 230, a control unit 240 and a digital signal outputting unit 250.

The signal receiving unit 210 receives a broadcast signal of terrestrial, cable and satellite broadcasts from countries around the world. Herein, the broadcast signal may be received in at least one of an analog format and a digital format, and if the broadcast signal is received in the digital format, the format may be one of QAM (Quadrature Amplitude Modulation), QFDM (Orthogonal Frequency Division Multiplexing), VSB (Vestigial Side Band) and QPSK (Quadrature Phase Shift Keying).

Herein, a VSB digital terrestrial broadcast may use various transmission methods including those recently being used in China such as DMB-T (Terrestrial Digital Multimedia Television Broadcasting), ADTB-T (Advanced Digital Television Broadcast-Terrestrial), BDB-T and CDTB-T as well as ATSC (Advanced Television Systems Committee) of the U.S., DVB-T of Europe based on COFDM (Coded Orthogonal Frequency Modulation), and ISDB-T of Japan based on BST-OFDM (Bandwidth Segmented Transmission-OFDM).

In addition, if a broadcast signal is received through an antenna, the signal receiving unit 210 may synchronize a digital broadcast signal, an analog broadcast signal and a certain type of digital broadcast signal and perform demodulation. A demodulated analog signal may be output after being converted into a digital signal.

The signal receiving unit 210 may output information about a channel selected by a Set Top Box's user through an interface (or a broadcast signal of a selected channel) under the control of the control unit 240. Before outputting a broadcast signal of the selected channel, the signal receiving unit 210 may synchronize the signal using a synchronizer and correct a distortion of a channel using an equalizer. Herein, digital image information about a channel selected by the signal receiving unit 210 includes information about a plurality of programs. For instance, various programs transmitted from different broadcasting companies may be included in one channel and be output.

The signal processing unit 220 receives a broadcast signal of a certain channel provided by the signal receiving unit 210 and divides the broadcast signal into video and audio data. It is naturally desirable to divide the broadcast signal into video and audio data corresponding to program information. The divided video and audio data may be stored in the memory unit 230 under the control of the control unit 240. If the signal processing unit 220 has microprocessors, each divided video and audio data may be controlled by the microprocessors and each microprocessor may receive the received video and audio data, respectively, and store the received video and audio data again in the memory unit 230, or performs a signal-processing after reading stored data. Herein, a signal-processing may include decoding, scaling or frame interpolation and the like.

The signal processing unit 220 modulates a broadcast signal into a digital channel format and outputs a result. In this process, the signal processing unit 220 may process the broadcast signal to meet a digital method used in a certain country. For instance, video and audio data may be modulated into a digital channel format such as QAM, VSB, QPSK and OFDM to meet the broadcast standard of ATSC and provide to the digital signal outputting unit 250. Herein, the signal processing unit 220 may multiplex video and audio data corresponding to each program and provide the video and audio data to the digital signal outputting unit 250.

According to exemplary embodiments, if a digital broadcast signal is received through the signal receiving unit 210, the signal processing unit 220 may naturally modulate the digital broadcast signal into another digital channel format and output a result. Herein, the modulation is performed to meet a transmission standard of a certain country. For instance, a VSB broadcast signal is received through the signal receiving unit 210, the signal processing unit 220 may output the broadcast signal as a QAM broadcast signal which meets a certain standard. Herein, if the QAM signal is a complex signal comprising real numbers (I) and imaginary numbers (Q), an 8VSB signal may be converted to an 8PAM (Pulse Amplitude Modulation) signal comprising only real numbers.

According to exemplary embodiments, the signal processing unit 220 includes a QAM modulator. As a result, a 16 QAM modulator may transmit 10 Mbps video and audio data and a 256 modulator may transmit 40 Mbps video and audio data.

The digital signal outputting unit 250 outputs video and audio data modulated into a digital format which is provided by the signal processing unit 220. The digital signal outputting unit 250 may be configured with a connector or a jack, with which an individual receiver 110 such as a digital broadcast receiver may be connected. As a result, the digital broadcast receiver receives a broadcast signal of various channels and displays the broadcast signal on a screen. Herein, the digital signal outputting unit 250 may provide a multi-room service as it can be connected with a plurality of receivers 110 through a jack.

According to exemplary embodiments, as digital transmission is performed inside of the device for receiving multi-channel broadcasting 100, the quality of image and audio may improve greater than that of the same when a broadcast signal is output with an analog method. In addition, the noise caused by a close channel may be reduced more greatly than when both digital and analog methods are used together.

According to exemplary embodiments, digital transmission enables image information about a plurality of programs to be transmitted to one channel so that functions such as PIP (Picture in Picture) and PVR (Personal Video Recorder) can be provided through the digital signal outputting unit 250 depending on a condition of the receiver 110. That is, a multi-room service may be provided through one cable.

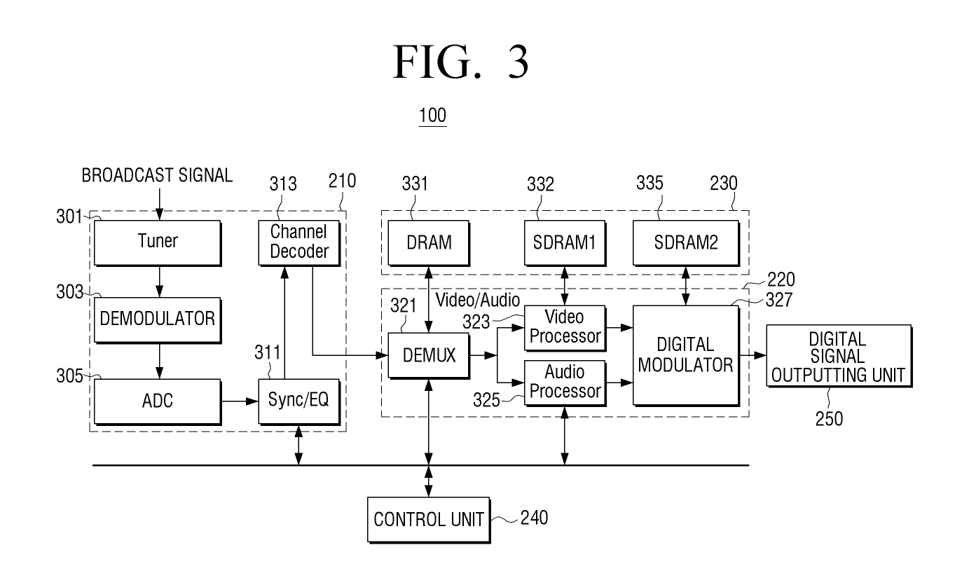

FIG. 3 is a view illustrating an example of a configuration of the device for receiving multi-channel broadcasting illustrated in FIG. 2.

Referring to FIGS. 2 and 3, the signal receiving unit 210 of the device for receiving multi-channel broadcasting 100 may include some or all of a tuner 301, a demodulator 303, an ADC (Analog Digital Converter) 305, a synchronizer and equalizer 311, and a channel decoder 313.

Herein, the tuner 301 may synchronize certain type of signals and output them, the demodulator 303 may demodulate a broadcast signal provided through the tuner 301 and the ADC may perform information transformation.

The synchronizer and equalizer 311 synchronize a channel selected by a user and correct a distortion of a channel. Herein, the synchronizer and equalizer 311 may operate under the control of the control unit 240.

The signal processing unit 220 may include some or all of a demux 321, video and audio processors 323, 325 and a digital modulator 327. The demux 321 may receive a broadcast signal of a selected channel, store the received broadcast signal interlocking with DRAM 331, divide the broadcast signal into video and audio data corresponding to each programs of the selected channel and provide them to the video processor 323 and the audio processor 325.

The video and audio processors 323, 325 perform a signal-processing of received video and audio data. Herein, the signal-processing may include decoding, scaling, frame interpolation and the like. In order to carry out the above-described operations, the video and audio processors 323, 325 may store information about a related signal in SDRAM 1 332 under the control of the control unit 240. The video and audio processors 323, 325 may naturally store a signal received from the demux 321 in SDRAM 1 332 and perform a signal-processing, However, it is noted that this process is only one example and other processes can be used.

The digital modulator 327 modulates a broadcast signal with at least one method of QAM, VSB, OFDM and QSPK, and outputs the result. Herein, it is desirable that the digital modulator 327 processes a received signal to meet a certain type of digital methods. In this process, the digital modulator 327 may store a related broadcast signal in SDRAM 2 335, read the broadcast signal and modulate it. While performing such processes, the digital modulator 327 can transmit a channel having a large data amount such as a High-Definition (HD) channel without degradation of image and audio quality.

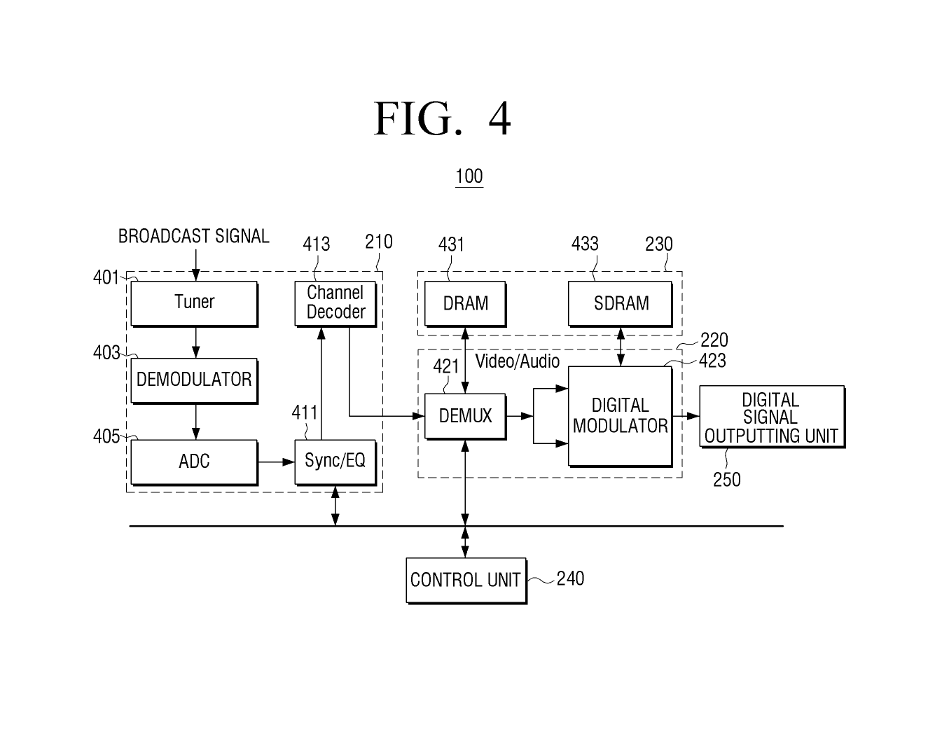

FIG. 4 is another view illustrating an example of a configuration of the device for receiving multi-channel broadcasting illustrated in FIG. 2.

Referring to FIGS. 2 and 4, according to exemplary embodiments, the signal processing unit 220 of the device for receiving multi-channel broadcasting 100 may include one or both of a demux 421 and a digital modulator 423. That is, the device for receiving multi-channel broadcasting 100 illustrated in FIG. 4 may does not include the video and audio processors 323, 325 and SDRAM 1 332 interlocking with the video processor 323 as shown in the configuration illustrated in FIG. 3.

In this case, the digital modulator 423 illustrated in FIG. 4 receives, for instance, video and audio data which are divided and provided by the demux 421, modulates a broadcast signal with at least one method of QAM, VSB, OFDM and QSPK and sends the broadcast signal to the digital image outputting unit 250. Herein, the digital modulator 423 may additionally process the signal to meet a certain standard, or a digital method used in a certain country. In the processes, after storing a related broadcast signal in SDRAM 433, the digital modulator 423 may modulate the broadcast signal by reading the broadcast signal.

Further details about operations of the signal unit 210 and the memory unit 230 illustrated in FIG. 4 are the same as those illustrated in FIG. 3, so they are not provided here.

For instance, if the device for receiving multi-channel broadcasting 100 illustrated in FIG. 4 does not need an additional data-processing or, in other words, only a digital broadcast signal is received from the signal receiving unit 210, the efficiency will be enhanced and this case is much more desirable.

Meanwhile, according to exemplary embodiments, the device for receiving multi-channel broadcasting 100 illustrated FIG. 2 may analyze a characteristic of a received digital broadcast signal, for example, a type of QAM, VSB, OFDM or QSPK, and determine a modulation format of a digital signal depending on the analyzed result even though a view illustrating this process is not provided. To this end, the device for receiving multi-channel broadcasting 100 may additionally include an image analyzing unit (Not illustrated) and a switching unit (Not illustrated). Herein, the switching unit may open a certain route depending on an analyzed result and the digital modulator 327 illustrated in FIG. 3 may modulate a broadcast signal with at least one method of QAM, VSB and OFDM, and output it.

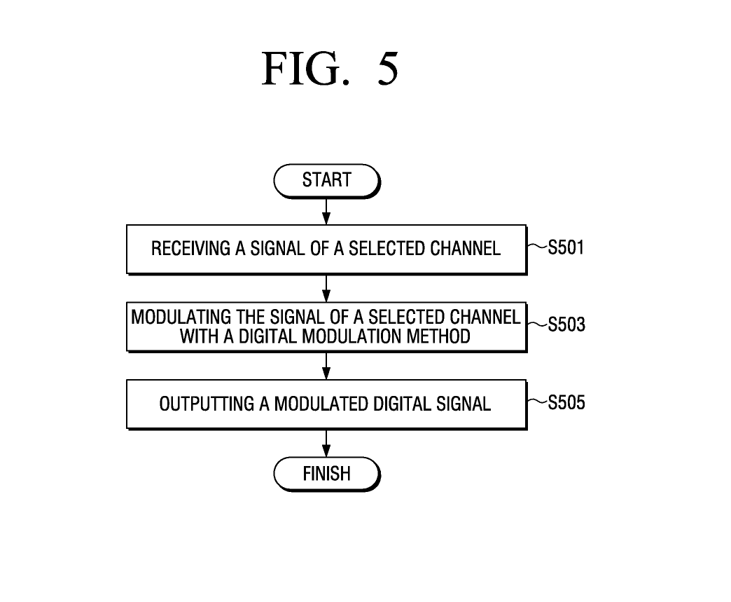

FIG. 5 is a diagram illustrating a method for receiving multi-channel broadcasting according to exemplary embodiments.

Referring to FIGS. 2 and 5, according to exemplary embodiments, the device for receiving multi-channel broadcasting 100 receives a broadcast signal of a selected channel through an antenna and demodulates the received broadcast signal. (S501)

In this process, if a mix of an analog broadcast signal and a digital broadcast signal is considered to be received, the device for receiving multi-channel broadcasting 100 may additionally convert the analog broadcast signal into a digital broadcast signal.

The device for receiving multi-channel broadcasting 100 may synchronize a channel selected by a user, correct a characteristic of received image information and perform a channel-decoding.

The device for receiving multi-channel broadcasting 100 modulates a broadcast signal of a selected channel with a digital modulation method. That is, an analog broadcast signal may be modulated into a digital broadcast signal or a received digital broadcast signal may be modulated into another digital signal in a different format from that of the previous. For instance, if a digital format of a received digital broadcast signal is VSB, OFDM or QSPK, the signal may be output after being converted into a format of QAM, or if the format is OFDM, QSPK and QAM, the signal may be output after being converted into a format of VSB. Herein, it is desirable that the converted digital broadcast is modulated to meet a certain standard, or a digital method used in a certain country.

After the process of 5501, if an image of the selected channel is analyzed additionally, the device for receiving multi-channel broadcasting 100 may additionally select a certain modulation method depending on the analyzing result. That is, a digital modulation method is determined depending on an image analyzing result or at least one modulation method is chosen. With regard of this process, since numerous variations could occur, the exemplary embodiments are not limit to this particular process.

The device for receiving multi-channel broadcasting 100 outputs digital image information modulated into a certain digital type. (S505) The modulated digital image information includes a plurality of programs of one channel. As a result, the device for receiving multi-channel broadcasting 100 may provide a large amount of data such as a High-Definition (HD) data to a digital broadcast receiver and the like.

The foregoing exemplary embodiments and advantages are merely exemplary and are not to be construed as limiting the inventive concept of the present application. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed:

1. A device for receiving multi-channel broadcasting comprises:
a signal receiving unit which receives a broadcast signal;
a control unit which controls the signal receiving unit to select a channel selected by a user and receive the broadcast signal; and
a signal processing unit which modulates the broadcast signal received from the signal receiving unit with a digital modulation method in accordance with a predetermined broadcasting standard.

2. The device as claimed in claim 1, wherein the signal processing unit converts an analog signal into a digital signal or a received first digital signal into a second digital signal which is different form from the first digital signal.

3. The device as claimed in claim 1, wherein the signal processing unit includes a digital modulator which modulates the broadcast signal of the selected channel with at least one method of QAM (Quadrature Amplitude Modulation), OFDM (Orthogonal Frequency Division Multiplexing), VSB (Vestigial Side Band) and QPSK (Quadrature Phase Shift).

4. The device as claimed in claim 3, wherein the signal processing unit further comprises:
a demux which divides the broadcast signal of the selected channel into video data and audio data and outputs the video data and the audio data;
a video processor which performs a signal-processing of the video data and provides a result of the signal-processing to the digital modulator; and
an audio processor which performs a signal-processing of the audio data and provides a result of the signal processing to the digital modulator.

5. The device as claimed in claim 3, wherein the digital modulator comprises a plurality of digital modulators and the signal receiving unit includes a switching unit which selects one of the plurality of digital modulators depending on a type of the broadcast signal.

6. The device as claimed in claim 1, wherein the broadcast signal of the selected channel includes information about a plurality of programs.

7. A method for receiving multi-channel broadcasting, comprising:
selecting a channel selected by a user and receiving a broadcast signal; and
modulating the received broadcast signal with a digital modulation method in accordance with a predetermined broadcasting standard and outputting the modulated received broadcast signal.

8. The method as claimed in claim 7, wherein the modulating the received broadcast signal with the digital modulation method and outputting the modulated received broadcast signal comprises modulating the broadcast signal with at least one method of QAM (Quadrature Amplitude Modulation), OFDM (Orthogonal Frequency Division Multiplexing), VSB (Vestigial Side Band) and QPSK (Quadrature Phase Shift).

9. The method as claimed in claim 8, wherein the modulating the received broadcast signal with the digital modulation method and outputting the modulated received broadcast signal comprises converting a received first digital signal into a second digital signal which is different form the first digital signal and outputting the second digital signal.

10. The method as claimed in claim 7, wherein the modulating the broadcast signal with the digital modulation method and outputting the modulated broadcast signal comprises using at least one of broadcasting standards of ATSC (Advanced Television Systems Committee), COFDM (Coded Orthogonal Frequency Modulation), BST-OFDM (Bandwidth Segmented Transmission-OFDM), ISDB-T (Integrated Services Digital Broadcast-Terrestrial), DMB-T (Terrestrial Digital Multimedia Television Broadcasting), ADTB-T (Advanced Digital Television Broadcast-Terrestrial), BDB-T, CDTB-T and SMCC (Synchronized Multi-Carrier CDMA).

11. A method for receiving multi-channel broadcasting, comprising:
receiving a broadcast signal of a user selected channel;
determining whether the received broadcast signal of the user selected channel comprises an analog broadcast signal and a digital broadcast signal, and if determined that the received broadcast signal comprises the analog broadcast signal, converting the analog broadcast signal into another digital broadcast signal;
synchronizing the digital broadcast signal and the other digital broadcast signal;
demodulating the synchronized digital broadcast signal;
modulating the synchronized digital broadcast signal with a digital modulation method in accordance with a predetermined broadcasting standard; and
outputting the modulated digital broadcast signal in accordance with the predetermined broadcasting standard.

12. The method as claimed in claim 11, wherein the modulating the synchronized digital broadcast signal with the digital modulation method comprises modulating the synchronized digital broadcast signal with at least one method of QAM (Quadrature Amplitude Modulation), OFDM (Orthogonal Frequency Division Multiplexing), VSB (Vestigial Side Band) and QPSK (Quadrature Phase Shift).

13. The method as claimed in claim 7, wherein the outputting the modulated digital broadcast signal comprises using at least one of broadcasting standards of ATSC (Advanced Television Systems Committee), COFDM (Coded Orthogonal Frequency Modulation), BST-OFDM (Bandwidth Segmented Transmission-OFDM), ISDB-T (Integrated Services Digital Broadcast-Terrestrial), DMB-T (Terrestrial Digital Multimedia Television Broadcasting), ADTB-T (Advanced Digital Television Broadcast-Terrestrial), BDB-T, CDTB-T and SMCC (Synchronized Multi-Carrier CDMA).
